(19) United States
(12) Patent Application Publication
(10) Pub. No.: US 2026/0046704 A1
(43) Pub. Date: Feb. 12, 2026

(54) CONFIGURING MULTIPLE EVENT CONDITION PARAMETER SETS FOR USER EQUIPMENT-INITIATED BEAM REPORTING

(71) Applicant: QUALCOMM Incorporated, San Diego, CA (US)

(72) Inventors: Doohyun SUNG, Basking Ridge, NJ (US); Naeem AKL, BRIDGEWATER, NJ (US); Jelena DAMNJANOVIC, Del Mar, CA (US)

(21) Appl. No.: 18/798,501

(22) Filed: Aug. 8, 2024

(51) Int. Cl. H04W 36/00; H04W 24/08

(52) U.S. Cl. CPC H04W 36/0058; H04W 24/08; H04W 36/0064

(57) ABSTRACT

Methods, systems, and devices for wireless communications are described. The described techniques may enable a UE to perform UE-initiated measurement reporting for lower layer triggered mobility (LTM). For example, a serving network entity may configure the UE with different sets of parameters for an entering condition and a leaving condition associated with an LTM event. For example, the UE may receive an event configuration indicating a first set of parameters for the entering condition and a second set of parameters for the leaving condition. In some examples, the UE may be configured with multiple sets of parameters, and may receive an indication of one or more sets of parameters of the multiple sets of parameters for the entering condition or for the leaving condition. In such examples, the UE may use one or more default sets of parameters for the entering condition or for the leaving condition.

### FIELD OF TECHNOLOGY

The following relates to wireless communications, including configuring multiple event condition parameter sets for user equipment (UE)-initiated beam reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating at least one set of parameters of a set of multiple sets of parameters for a lower layer triggered mobility (LTM) event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity, monitoring for one or more transmissions from the serving network entity or the neighboring network entity based on the control signaling, and transmitting an event-triggered measurement report for LTM based on at least one measurement of the one or more transmissions satisfying one or more parameters of the first set of parameters or one or more parameters of the second set of parameters.

A UE for wireless communications is described. The UE may include one or more memories storing processor executable code, and one or more processors coupled with the one or more memories. The one or more processors may individually or collectively be operable to execute the code to cause the UE to receive control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity, monitor for one or more transmissions from the serving network entity or the neighboring network entity based on the control signaling, and transmit an event-triggered measurement report for LTM based on at least one measurement of the one or more transmissions satisfying one or more parameters of the first set of parameters or one or more parameters of the second set of parameters.

Another UE for wireless communications is described. The UE may include means for receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity, means for monitoring for one or more transmissions from the serving network entity or the neighboring network entity based on the control signaling, and means for transmitting an event-triggered measurement report for LTM based on at least one measurement of the one or more transmissions satisfying one or more parameters of the first set of parameters or one or more parameters of the second set of parameters.

A non-transitory computer-readable medium storing code for wireless communications is described. The code may include instructions executable by one or more processors to receive control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity, monitor for one or more transmissions from the serving network entity or the neighboring network entity based on the control signaling, and transmit an event-triggered measurement report for LTM based on at least one measurement of the one or more transmissions satisfying one or more parameters of the first set of parameters or one or more parameters of the second set of parameters.

In some examples of the method, UEs, and non-transitory computer-readable medium described herein, the first set of parameters may be different from the second set of parameters.

In some examples of the method, UEs, and non-transitory computer-readable medium described herein, receiving the control signaling may include operations, features, means, or instructions for receiving the control signaling indicating the first set of parameters and the second set of parameters.

In some examples of the method, UEs, and non-transitory computer-readable medium described herein, receiving the control signaling may include operations, features, means, or instructions for receiving an indication of a set of multiple values for a parameter, where a first value of the set of multiple values applies to the first set of parameters and where a second value of the set of multiple values applies to the second set of parameters.

In some examples of the method, UEs, and non-transitory computer-readable medium described herein, receiving the control signaling may include operations, features, means, or instructions for receiving an indication of one of the first set of parameters or the second set of parameters, where the other of the first set of parameters or the second set of parameters may be a default set of parameters.

In some examples of the method, UEs, and non-transitory computer-readable medium described herein, receiving the control signaling may include operations, features, means, or instructions for receiving an indication of whether the control signaling indicates the first set of parameters or the second set of parameters.

In some examples of the method, UEs, and non-transitory computer-readable medium described herein, receiving the control signaling may include operations, features, means, or instructions for receiving an indication of the set of multiple sets of parameters.

Some examples of the method, UEs, and non-transitory computer-readable medium described herein may further include operations, features, means, or instructions for receiving additional control signaling indicating an identifier (ID) associated with the first set of parameters, the second set of parameters, or both.

Some examples of the method, UEs, and non-transitory computer-readable medium described herein may further include operations, features, means, or instructions for deactivating one or more sets of parameters based on receiving the additional control signaling.

Some examples of the method, UEs, and non-transitory computer-readable medium described herein may further include operations, features, means, or instructions for receiving a deactivation message that deactivates a set of parameters of the set of multiple sets of parameters, where the first set of parameters, the second set of parameters, or both may be a default set of parameters based on the deactivation message.

In some examples of the method, UEs, and non-transitory computer-readable medium described herein, the first set of parameters, the second set of parameters, or both may be a default set of parameters of the set of multiple sets of parameters.

Some examples of the method, UEs, and non-transitory computer-readable medium described herein may further include operations, features, means, or instructions for receiving system information indicating the default set of parameters.

In some examples of the method, UEs, and non-transitory computer-readable medium described herein, the first set of parameters, the second set of parameters, or both may be associated with a default parameter ID.

In some examples of the method, UEs, and non-transitory computer-readable medium described herein, the default set of parameters may be defined according to a rule.

Some examples of the method, UEs, and non-transitory computer-readable medium described herein may further include operations, features, means, or instructions for receiving additional control signaling indicating an update to one or more sets of parameters of the set of multiple sets of parameters.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports configuring multiple event condition parameter sets for user equipment (UE)-initiated beam reporting in accordance with one or more aspects of the present disclosure.

FIG. 2 shows an example of a wireless communications system that supports configuring multiple event condition parameter sets for UE-initiated beam reporting in accordance with one or more aspects of the present disclosure.

FIGS. 3A and 3B show examples of measurement quality diagrams that support configuring multiple event condition parameter sets for UE-initiated beam reporting in accordance with one or more aspects of the present disclosure.

FIG. 4 shows an example of a process flow that supports configuring multiple event condition parameter sets for UE-initiated beam reporting in accordance with one or more aspects of the present disclosure.

FIGS. 5 and 6 show block diagrams of devices that support configuring multiple event condition parameter sets for UE-initiated beam reporting in accordance with one or more aspects of the present disclosure.

FIG. 7 shows a block diagram of a communications manager that supports configuring multiple event condition parameter sets for UE-initiated beam reporting in accordance with one or more aspects of the present disclosure.

FIG. 8 shows a diagram of a system including a device that supports configuring multiple event condition parameter sets for UE-initiated beam reporting in accordance with one or more aspects of the present disclosure.

FIGS. 9 through 11 show flowcharts illustrating methods that support configuring multiple event condition parameter sets for UE-initiated beam reporting in accordance with one or more aspects of the present disclosure.

### DETAILED DESCRIPTION

In some wireless communications systems, to enable lower layer triggered mobility (LTM), a user equipment (UE) may be configured to perform beam reporting based on one or more events that trigger a beam report, which may be referred to as UE-initiated beam reporting. For example, the UE may measure and report a quality (e.g., a signal strength, a signal-to-noise ratio (SNR)) of one or more current beams used for communication with a network entity (e.g., a serving network entity) and one or more candidate beams (e.g., associated with the serving network entity or a serving network entity) when one or more events are triggered for UE-initiated beam reporting (e.g., channel state information (CSI) reporting). Each event may be associated with a set of one or more parameters identifying one or more conditions for the UE to add or remove a network entity to a list of network entities that the UE includes in a beam report (e.g., a CSI report). In some examples, however, using a same parameter set for adding or removing the network entity from the list of network entities may increase latency in the wireless communications system. For example, the UE may not transmit a report indicating for a network entity to be removed from the list until expiration of a timing offset associated with the event, which may increase latency associated with performing a handover and may therefore result in a relatively lower quality of communications for the UE.

Accordingly, techniques described herein may enable a serving network entity to configure the UE with different sets of parameters for an entering condition associated with an event (e.g., adding a network entity to the list of network entities being monitored) and for a leaving condition associated with the event (e.g., removing a network entity from the list of network entities being monitored). For example, the UE may receive an event configuration indicating a first set of parameters for the entering condition and a second set of parameters for the leaving condition.

In some examples, the UE may be configured with multiple sets of parameters, and may receive an indication of an identifier (ID) associated with one or more sets of parameters of the multiple sets of parameters for the entering condition, for the leaving condition, or both. In some examples, the UE may use one or more default sets of parameters until receiving the indication of the ID (e.g., default sets of parameters indicated via system information or according to a rule defined in a technical specification, or sets of parameters associated with a default ID).

Aspects of the disclosure are initially described in the context of wireless communications systems. Aspects of the disclosure are further illustrated by and described with reference to measurement quality diagrams, process flows, apparatus diagrams, system diagrams, and flowcharts that relate to configuring multiple event condition parameter sets for UE-initiated beam reporting.

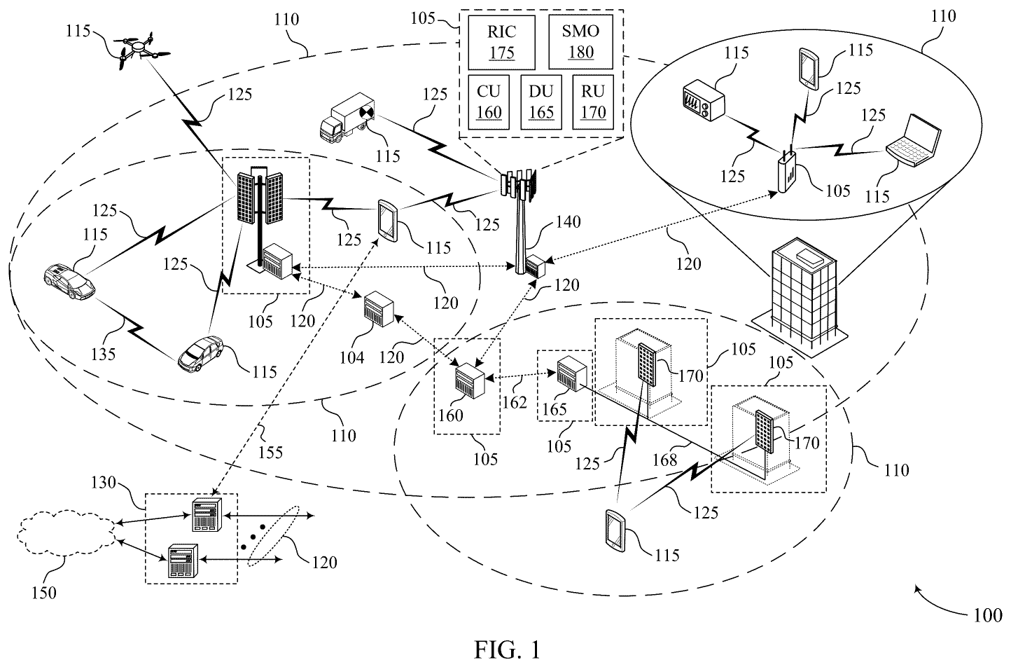

FIG. 1 shows an example of a wireless communications system 100 that supports configuring multiple event condition parameter sets for UE-initiated beam reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, to enable a UE 115 to perform UE-initiated measurement reporting for LTM, a serving network entity 105 may configure the UE 115 with different sets of parameters for an entering condition associated with an LTM event (e.g., adding a network entity 105 to a list of network entities for which the UE 115 reports measurement quality) and for a leaving condition associated with the event (e.g., removing a network entity 105 from the list of network entities). For example, the UE 115 may receive an event configuration indicating a first set of parameters for the entering condition and a second set of parameters for the leaving condition. In some examples, the UE 115 may be configured with multiple sets of parameters, and may receive an indication of an ID associated with one or more sets of parameters of the multiple sets of parameters for the entering condition or for the leaving condition. In such examples, the UE 115 may use one or more default sets of parameters until receiving the indication of the ID (e.g., default sets of parameters indicated via system information or according to a rule defined in a technical specification, or sets of parameters associated with a default ID.

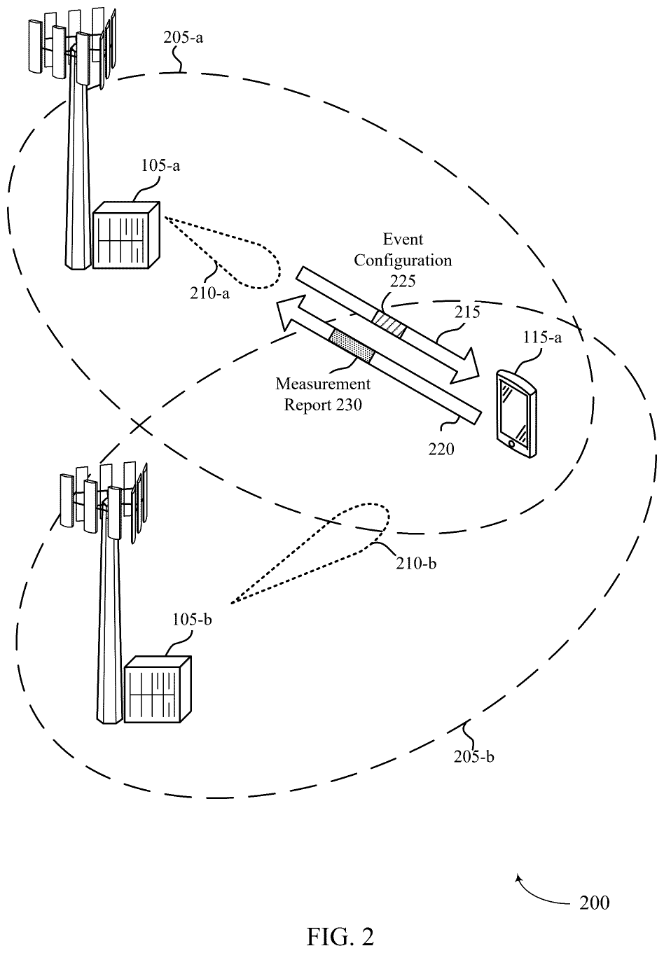

FIG. 2 shows an example of a wireless communications system 200 that supports configuring multiple event condition parameter sets for UE-initiated beam reporting in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or one or more network entities 105 (e.g., a network entity 105-a, a network entity 105-b), which may be examples of the corresponding devices as described with reference to FIG. 1.

In some examples of the wireless communications system 200, a UE 115-a may communicate with a network entity 105-a (e.g., a serving cell) via one or more channels. For example, the UE 115-a may transmit one or more uplink messages to the network entity 105-a via an uplink channel 220 and may receive one or more downlink messages from the network entity 105-a via a downlink channel 215.

The UE 115-a may operate according to LTM. In such examples, the UE 115-a may communicate with the serving cell (e.g., in a cell 205-a of the network entity 105-a) and may switch serving cells (e.g., to a cell 205-b of a neighboring network entity 105-b) based on L1 or L2 signaling (e.g., without changing one or more configuration parameters associated with upper layers and/or lower layers). Accordingly, the UE 115-a may dynamically switch between LTM candidate cells (e.g., the network entity 105-a and the network entity 105-b) if a beam 210-b of the network entity 105-b has a higher quality than a beam 210-a of the network entity 105-a, which may enable a relatively higher quality of communication associated with the UE 115-a by reducing a latency associated with switching cells. As described herein, a beam 210 may also be referred to as a spatial filter (e.g., a transmission spatial filter) or spatial characteristics (e.g., transmission spatial characteristics).

For example, the UE 115-a may communicate with the network entity 105-a via the beam 210-a. The UE 115-a may perform one or more measurements (e.g., beam measurements based on channel state information reference signals (CSI-RSs) or synchronization signal blocks (SSBs)) of the beam 210-a and of the beam 210-b associated with the network entity 105-b to support LTM. In some examples, measurement-related enhancements for LTM may be applicable to intra- and inter-CU (e.g., inter- and intra-cell) beam management for master cell groups (MCGs) and secondary cell groups (SCGs). In some examples, to support event-triggered L1 measurement reporting of the network entity 105-a and/or the network entity 105-b (e.g., one or more RAN nodes).

Accordingly, to support CSI-RS measurements for LTM procedures and to enable CSI-RS-based beam management (e.g., and other physical layer operations on candidate cells, such as the cell 205-b), the UE 115-b may receive an event configuration 225 from the network entity 105-a that configures the UE 115-a with one or more events that may trigger the UE 115-a to transmit a measurement report 230. The measurement report 230 may enable the network entity 105-a to select a candidate beam 210, or candidate cell 205, or both, for the UE 115-a to perform an LTM cell switch procedure to switch to (e.g., or to trigger an early synchronization). In some examples, the UE 115-a may use beam level measurements to evaluate whether an event has occurred (e.g., to trigger the UE 115-a to transmit the measurement report).

The one or more events may include an event in which a quality of a beam 210 of the serving cell 205-a (e.g., the beam 210-a) becomes worse than a threshold (e.g., an absolute threshold). Additionally, or alternatively, the one or more events may include an event in which a quality of a beam 210 of the neighboring cell 205-b (e.g., the beam 210-b) becomes better than a threshold (e.g., an absolute threshold). Additionally, or alternatively, the one or more events may include an event in which the quality of the beam 210 of the neighboring cell 205-b becomes an offset amount better than the quality of the beam 210 of the serving cell 205-a. Additionally, or alternatively, the one or more events may include a combination of events (e.g., an event in which the quality of the beam 210 of the serving cell 205-a becomes worse than a threshold and the quality of the beam 210 of the neighboring cell 205-b becomes an offset amount better than the quality of the beam 210 of the serving cell 205-a).

In some examples, the UE 115-a may be configured with beams over which the UE 115-a may perform L1 beam measurements for both synchronization signal blocks (SSBs) and CSI-RSs (e.g., via an L1 measurement resource configuration in an LTM configuration). In some examples, a same reference signal type (e.g., SSB or CSI-RS) may be used for both of the serving cell 205-a and the candidate (e.g., neighboring) cell 205-b (e.g., for events in which the UE 115-b evaluates the quality of both of the beam 210-a and the beam 210-b). In some examples, the network entity 105-a may assume that the UE 115-a may perform a specified L1 filtering of beam measurement results, may indicate to the UE 115-a whether to perform the L1 filtering of beam measurement results, or may enable the UE 115-a to determine whether to perform the L1 filtering of beam measurement results.

In some examples, for L3 beam reporting, an event configuration 225 may include a parameter set of one or more parameters for the respective event. The one or more parameters may include a hysteresis, a time to trigger, an offset, a threshold, or any combination thereof, for an entering condition and a leaving condition associated with the event. For example, the entering condition may be a condition that triggers the UE 115-a to include a respective beam (e.g., the beam 210-a, the beam 210-b) in the measurement report 230. The leaving condition may be a condition that triggers the UE 115-a to include a respective beam (e.g., the beam 210-a, the beam 210-b) in the measurement report 230 if a parameter (e.g., reportOnLeave) is set to true and to stop including the respective beam (e.g., the beam 210-a, the beam 210-b) in the measurement report 230 if the parameter is set to false.

For example, if a parameter (e.g., reportType) is set to eventTriggered, a corresponding parameter reportConfig does not include an indicated quantity of triggering cells (e.g., numberOfTriggeringCells), the entering condition (e.g., an entering condition of an event corresponding with an eventID of a corresponding repotConfig in an information element (IE) VarMeasConfig) is satisfied for a given event for one or more applicable cells for a time period timeToTrigger, and if a list (e.g., VarMeasReportList) does not include a measurement ID (e.g., measID) of the one or more applicable cells, the UE 115-a may add the one or more applicable cells to a list of network entities 105-a that the UE 115-a includes in the measurement report 230 (e.g., a measurement report list). If the parameter (e.g., reportType) is set to eventTriggered, the leaving condition (e.g., a leaving condition of an event corresponding with an eventID of a corresponding repotConfig in an IE VarMeasConfig) is satisfied for a given event for the one or more applicable cells for the time period timeToTrigger, and if a list (e.g., VarMeasReportList) does include a measurement ID (e.g., measID) of the one or more applicable cells, the UE 115-a may remove the one or more applicable cells from the list of network entities 105-a that the UE 115-a includes in the measurement report 230.

As an illustrative example, for an event in which the quality of the beam 210-b of the neighboring cell 205-b becomes an offset amount better than the quality of the beam 210-a of the serving cell 205-a, the UE 115-a may evaluate a measurement quality of the beam 210-a and of the beam 210-b to determine whether the entering condition and/or the leaving condition are satisfied. For example, for the entering condition, the UE 115-a may determine whether a quantity Mp+Ofp+Ocp+Off is a hysteresis amount lower than a quantity Mn+Ofn+Ocn for a time period timeToTrigger, where Mp is a measurement result of the serving cell 205-a (e.g., a special cell (SpCell), the beam 210-a), Ofp is a measurement object-specific offset of a reference signal transmitted in the serving cell 205-a, Ocp is a cell-specific offset of the serving cell 205-a, Off is a configured offset parameter for the event, Mn is a measurement result of the neighboring cell 205-a (e.g., the beam 210-b), Ofp is a measurement object-specific offset of a reference signal transmitted in the neighboring cell 205-b, and Ocn is a cell-specific offset of the neighboring cell 205-b. For the leaving condition, the UE 115-a may determine whether the quantity Mp+Ofp+Ocp+Off is the hysteresis amount above the quantity Mn+Ofn+Ocn for the time period timeToTrigger.

For an event in which a quality of the beam 210-a of the serving cell 205-a becomes worse than a threshold, the UE 115-a may evaluate a measurement quality of the beam 210-a to determine whether the entering condition and/or the leaving condition are satisfied. For example, for the entering condition, the UE 115-a may determine whether a quantity Ms is a hysteresis amount lower than a threshold for a time period timeToTrigger, where Ms is a measurement result of the serving cell 205-a (e.g., a SpCell, the beam 210-a). For the leaving condition, the UE 115-a may determine whether the quantity Ms is the hysteresis amount above the threshold for the time period timeToTrigger. For an event in which the quality of the beam 210-a of the serving cell 205-a becomes worse than a threshold and the quality of the beam 210-b of the neighboring cell 205-b becomes an offset amount better than the quality of the beam 210-a of the serving cell 205-a, the UE 115-a may evaluate a measurement quality of the beam 210-a and of the beam 210-b to determine whether both respective entering conditions and/or the leaving conditions are satisfied.

For an event in which a quality of the beam 210-b of the neighboring cell 205-b becomes better than a threshold, the UE 115-a may evaluate a measurement quality of the beam 210-b to determine whether the entering condition and/or the leaving condition are satisfied. For example, for the entering condition, the UE 115-a may determine whether a quantity Mn+Ofn+Ocn is a hysteresis amount higher than a threshold for a time period timeToTrigger. For the leaving condition, the UE 115-a may determine whether the quantity Mn+Ofn+Ocn is the hysteresis amount below the threshold for the time period timeToTrigger.

In some examples, the parameter set (e.g., a parameter set configured semi-statically via RRC) for a given event may include a same hysteresis, time to trigger, threshold, and/or offset that the UE 115-a may apply for both of the entering condition and the leaving condition. Such symmetric parameters for entering the leaving conditions may prevent a frequent addition or removal of a measurement ID in a measurement report list (e.g., for a L3 measurement report that may inform the network entity 105-a of potential channel degradation of neighboring cells). However, such symmetric parameters may not be suitable for LTM (e.g., L1 measurements) due to a relatively shorter cell switch latency as compared to L3 handover. For example, LTM may include a pre-activation of one or more transmission configuration indicator (TCI) states (e.g., a TCI state that defines a beam 210) from the candidate (e.g., neighboring) cell 205-b, which may reduce a TCI state activation latency after cell switching. In such examples, if a TCI state of the beam 210-b of the neighboring cell 205-b becomes worse than the beam 210-a, the UE 115-a may have a relatively improved use of processing capability if the UE 115-a reacts relatively faster to the leaving condition and transmits an L1 measurement report (e.g., to enable the network entity 105-a to deactivate the TCI state of the beam 210-b and activate a TCI state associated with a different candidate beam). Additionally, RRC-based semi-static event configurations may have a relatively longer latency than other configuration techniques, which may increase latency and therefore reduce an efficiency of the LTM scheme.

Accordingly, in some examples, the UE 115-a may use a first parameter set for an entering condition associated with a first event (e.g., a first offset, a first threshold, a first hysteresis, and/or a first time to trigger) and a second parameter set (e.g., a second offset, a second threshold, a second hysteresis, and/or a second time to trigger) for a leaving condition associated with the first event. In some implementations, the event configuration 225 may include multiple (e.g., two) different parameter sets for each LTM event (e.g., an LTM event configured by RRC). In some examples, the RRC message may include an LTM event configuration IE that indicates a list of each parameter of the first parameter set and the second parameter set (e.g., as a flattened configuration). Additionally, or alternatively, the RRC message may include an LTM event configuration IE including respective IEs for the first parameter set and for the second parameter set (e.g., as a hierarchical configuration).

In some examples, parameters included in the first parameter set and the second parameter set may depend on an LTM event type of the first event. For example, for an event in which a quality of the beam 210-a of the serving cell 205-a becomes worse than a threshold or an event in which a quality of the beam 210-b of the neighboring cell 205-b becomes better than a threshold, the first parameter set and the second parameter set may include a respective hysteresis, threshold, and/or time to trigger. For an event in which the quality of the beam 210-b of the neighboring cell 205-b becomes an offset amount better than the quality of the beam 210-a of the serving cell 205-a, the first parameter set and the second parameter set may include a respective hysteresis, offset, and/or time to trigger. In some cases, the second parameter set may be a subset of parameters from the first parameter set. For example, the first parameter set may include parameters of offset, one or more threshold(s), hysteresis, and time to trigger, the second parameter set may include less than all of the parameters from the first parameter set. In some cases, the second parameter set may be a subset of parameters from the first parameter set, where the subset may be dependent on an LTM event type. For example, the second parameter set may include the parameter subset of offset, one or more threshold(s), hysteresis from the first parameter set for a first LTM event type, and the second parameter set may include the parameter subset of one or more threshold(s), hysteresis, and time to trigger, from the first parameter set for a second LTM event type.

In some implementations, the UE 115-a may receive an independent configuration for both of the entering condition and the leaving condition (e.g., up to each parameter set can be signaled with different options in control signaling, such as RRC signaling). For example, the UE 115-a may receive an explicit indication of a value for each parameter in each parameter set (e.g., even if one or more of the parameters have a same value, such hysteresis values are provided explicitly for each parameter set even though the hysteresis values are same). In some implementations, the UE 115-a may receive a dependent configuration for the entering condition and/or the leaving condition. For example, the UE 115-a may receive a parameter set (e.g., a default parameter set) for the entering condition and the leaving condition, and may receive (e.g., optionally) one or more additional parameters that may overwrite one or more values of the received parameter set for one of the entering condition or the leaving condition, or both. For example, for an event in which the quality of the beam 210-b of the neighboring cell 205-b becomes an offset amount better than the quality of the beam 210-a of the serving cell 205-a, the UE 115-a may receive an offset, hysteresis, and time to trigger for both of the entering and leaving condition. The UE 115-a may receive additional parameters, such as a second hysteresis and a second time to trigger, which the UE 115-a may apply to one of the entering condition or the leaving condition (e.g., while using the offset value for both of the entering condition and the leaving condition).

In some implementations, the UE 115-a may use a default value configuration for one of the entering condition or the leaving condition. For example, the UE 115-a may identify a default parameter set for an event (e.g., defined in system information, such as in a system information block (SIB) from the network entity 105-a, or defined according to a rule in a technical specification). The UE 115-a may receive, via the event configuration 225, a single parameter set that may apply to one of the entering condition or the leaving condition. For example, the event configuration 225 may include an indication of whether the signaled parameter set applies to the entering condition or to the leaving condition for the event. Additionally, or alternatively, the UE 115-a may determine whether the signaled parameter set applies to the entering condition or to the leaving condition for the event based on a rule defined in a technical specification. The UE 115-a may use the default parameter set for the other of the entering condition or the leaving condition. For example, the signaled parameter set may be used for the entering condition and the default parameter set may be used for the leaving condition, or vice-versa. In another example, a single parameter set is provided to the UE 115-a for either entering or leaving condition, and the UE 115-a is assumed to use the default parameter value set for the other of the entering or leaving condition.

In some implementations, the UE 115-a may be configured with multiple parameter sets in each event configuration 225 for each event (e.g., via SIB, via RRC, according to a rule in a technical specification). The UE 115-a may select a parameter set of the multiple parameter sets to use for each of the entering condition and the leaving condition (e.g., based on receiving lower-layer signaling, such as a MAC control element (MAC-CE) or downlink control information (DCI), indicating the selected parameter sets). In some examples, the lower-layer signaling may indicate an ID associated with the one or more indicated parameter sets. For example, the configuration of the multiple parameter sets may include an explicit ID associated with each of the multiple parameter sets, and the lower-layer signaling may indicate the explicit ID of the one or more selected parameter sets for the entering condition or the leaving condition, or both. Additionally, or alternatively, the lower-layer signaling may indicate an implicit index (e.g., an ordinal index) of the selected parameter sets.

In some examples, after receiving an RRC configuration or reconfiguration (e.g., prior to or without receiving the lower-layer signaling indicating the selected parameter sets), the UE 115-a may use one or more parameter sets of the multiple parameter sets for the entering condition and the leaving condition. For example, the UE 115-a may use one or more parameter sets with a lowest or highest ID of the multiple parameter sets, or one or more parameter sets that are ordinally first or last of the multiple parameter sets. Additionally, or alternatively, the UE 115-a may use one or more default parameter sets for the entering and leaving conditions (e.g., default parameter sets defined in system information, such as in a SIB from the network entity 105-a, or defined according to a rule in a technical specification). Additionally, or alternatively, the UE 115-a may not perform, or may not be expected to perform, any event-triggered measurements until selection of a parameter set occurs (e.g., until receiving the lower-layer signaling indicating the selected parameter sets).

In some implementations, a set selection process for the UE 115-a to identify the selected parameter sets may be an activation and deactivation process. For example, the lower-layer signaling may activate or deactivate one or more parameter sets to be used by the UE 115-a for the entering condition and the leaving condition. In some examples, prior to receiving the lower-layer signaling that activates or deactivates the one or more parameter sets, the UE 115-a may use one or more default parameter sets or may refrain from performing any event-triggered measurements until receiving the lower-layer signaling, as described herein. In some examples, if the UE 115-a is activated with a first parameter set for one or both of the entering condition or the leaving condition, the UE 115-a may determine to deactivate the first parameter set if the UE 115-a receives lower-layer signaling that activates a second parameter set (e.g., without receiving a separate deactivation message). Additionally, or alternatively, if the UE 115-a receives a deactivation message that deactivates the first parameter set (e.g., without receiving an activation message for a second parameter set), the UE 115-a may fall back to a default parameter set if available (e.g., a default parameter set defined in system information, such as in a SIB from the network entity 105-a, or defined according to a rule in a technical specification).

In some examples, the network entity 105-a may directly update one or more event configurations 225. For example, the network entity 105-a may transmit an event configuration 225 (e.g., via RRC) indicating one or more parameter sets for an event, and may transmit an indication of an update to one or more values to the one or more parameter sets (e.g., via lower-layer signaling, such as MAC-CE or DCI). The updated parameters may include, for example, an updated hysteresis, time to trigger, offset, threshold value, or any combination thereof. In some examples, if the UE 115-a is configured with multiple parameter sets, the lower-layer signaling may include a set ID (e.g., an explicit or implicit ID) corresponding to a parameter set for which the updated values apply.

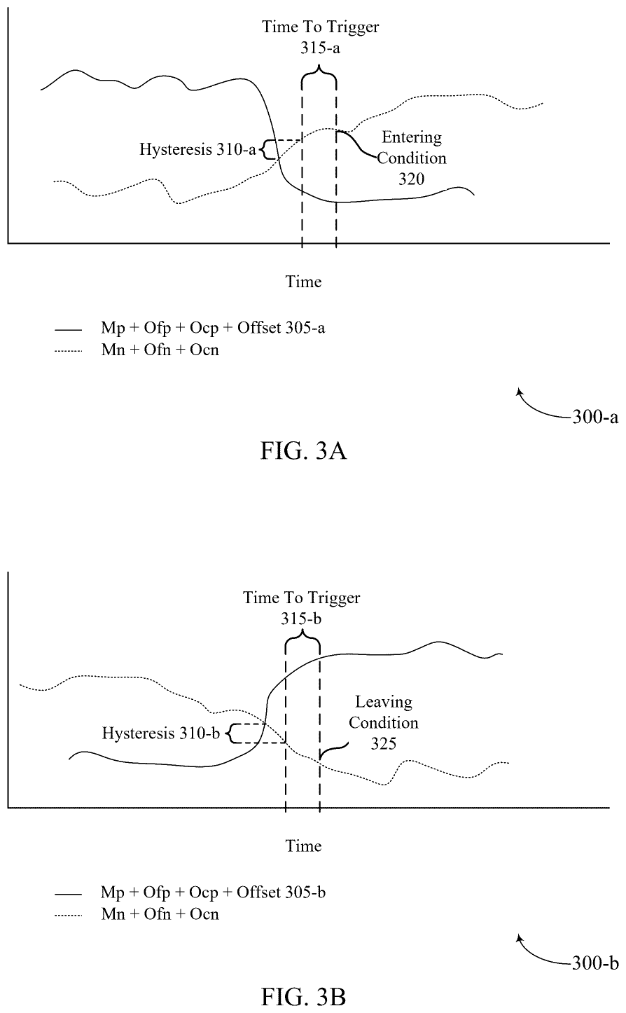

FIGS. 3A and 3B show examples of a measurement quality diagram 300-a and a measurement quality diagram 300-b, respectively, that support configuring multiple event condition parameter sets for UE-initiated beam reporting in accordance with one or more aspects of the present disclosure. The measurement quality diagram 300-a and the measurement quality diagram 300-b may implement or may be implemented by aspects of the wireless communications system 100 or the wireless communications system 200. For example, the measurement quality diagram 300-a and the measurement quality diagram 300-b may be implemented by a UE 115 or one or more network entities 105, which may be examples of the corresponding devices as described with reference to FIG. 1.

In some examples, as described with reference to FIG. 2, a UE 115 may use LTM techniques to perform a cell switch with relatively less latency as compared to higher layer (e.g., L3) mobility techniques. For example, the UE 115 may be configured with one or more events that may trigger the UE 115 to transmit a measurement report to a network entity 105 (e.g., a serving cell) that indicates a measurement quality associated with one or more beams of one or more candidate cells (e.g., one or more neighboring network entities 105) and/or of the network entity 105.

In some examples, to determine which network entities 105 the UE 115 may include in the measurement report, the UE 115 may evaluate an entering condition and a leaving condition associated with one or more configured events. In some examples, as described with reference to FIG. 2, each of the entering condition and the leaving condition for each configured event may be associated with a respective set of parameters. That is, the UE 115 may use a first set of parameters to evaluate the entering condition, and may use a second set of parameters to evaluate the leaving condition.

As an illustrative example, for an event in which a quality of a beam of a neighboring cell becomes an offset amount better than a quality of the beam of the serving cell, the UE 115 may evaluate a measurement quality of the beam and of the beam to determine whether an entering condition 320 and/or a leaving condition 325 are satisfied. For example, as illustrated with reference to the measurement quality diagram 300-a, for the entering condition 320, the UE 115 may determine whether a quantity Mp+Ofp+Ocp+Offset 305-a is a hysteresis 310-a (e.g., a hysteresis configured for the entering condition 320) amount lower than a quantity Mn+Ofn+Ocn for a time period time to trigger 315-a (e.g., a time to trigger configured for the entering condition 320). As described with reference to FIG. 2, Mp may be a measurement result of the serving cell, Ofp may be a measurement object-specific offset of a reference signal transmitted in the serving cell, Ocp may be a cell-specific offset of the serving cell, Offset 305-a may be a configured offset parameter for the entering condition 320 for the event, Mn may be a measurement result of the neighboring cell, Ofp may be a measurement object-specific offset of a reference signal transmitted in the neighboring cell, and Ocn may be a cell-specific offset of the neighboring cell.

For the leaving condition 325, as illustrated with reference to the measurement quality diagram 300-b, the UE 115 may determine whether a quantity Mp+Ofp+Ocp+Offset 305-b is a hysteresis 310-b (e.g., a hysteresis configured for the leaving condition 325) amount above the quantity Mn+Ofn+Ocn for the time period time to trigger 315-b (e.g., a time to trigger configured for the leaving condition 325). In some examples, the hysteresis 310-a, the time to trigger 315-a, and the offset 305-a may be respective parameter values of a first set of parameters, and the hysteresis 310-b, the time to trigger 315-b, and the offset 305-b may be respective parameter values of a second set of parameters. In some examples, one or more values of the first set of parameters and the second set of parameters may be the same, or may be different. One or more values of the first set of parameters or the second set of parameters may be default values.

In some examples, the UE 115 may use different respective parameter sets for entering and leaving conditions for one or more different types of events than those illustrated with reference to FIGS. 3A and 3B. For example, for an event in which a quality of the beam of the serving cell becomes worse than a threshold, the UE 115 may evaluate a measurement quality of the beam of the serving cell to determine whether an entering condition and/or a leaving condition are satisfied. For example, for the entering condition, the UE 115-a may determine whether a quantity Ms is a first hysteresis amount lower than a first threshold for a first time period, where Ms is a measurement result of the serving cell, and the first hysteresis, first threshold, and first time period are respective parameters of a first parameter set. For the leaving condition, the UE 115 may determine whether the quantity Ms is a second hysteresis amount above a second threshold for a second time period, where the second hysteresis, second threshold, and second time period are respective parameters of a second parameter set. For an event in which the quality of the beam of the serving cell becomes worse than a threshold and the quality of the beam of the neighboring cell becomes an offset amount better than the quality of the beam of the serving cell, the UE 115 may evaluate a measurement quality of the beam of the serving cell and the beam of the neighboring cell to determine whether both respective entering conditions and/or the leaving conditions are satisfied.

For an event in which a quality of the beam of the neighboring cell 205-b becomes better than a threshold, the UE 115 may evaluate a measurement quality of the beam 210 of the neighboring cell to determine whether the entering condition and/or the leaving condition are satisfied. For example, for the entering condition, the UE 115 may determine whether a quantity Mn+Ofn+Ocn is a first hysteresis amount lower than a first threshold for a first time period, where the first hysteresis, first threshold, and first time period are respective parameters of a first parameter set. For the leaving condition, the UE 115 may determine whether the quantity Mn+Ofn+Ocn is a second hysteresis amount above a second threshold for a second time period, where the second hysteresis, second threshold, and second time period are respective parameters of a second parameter set.

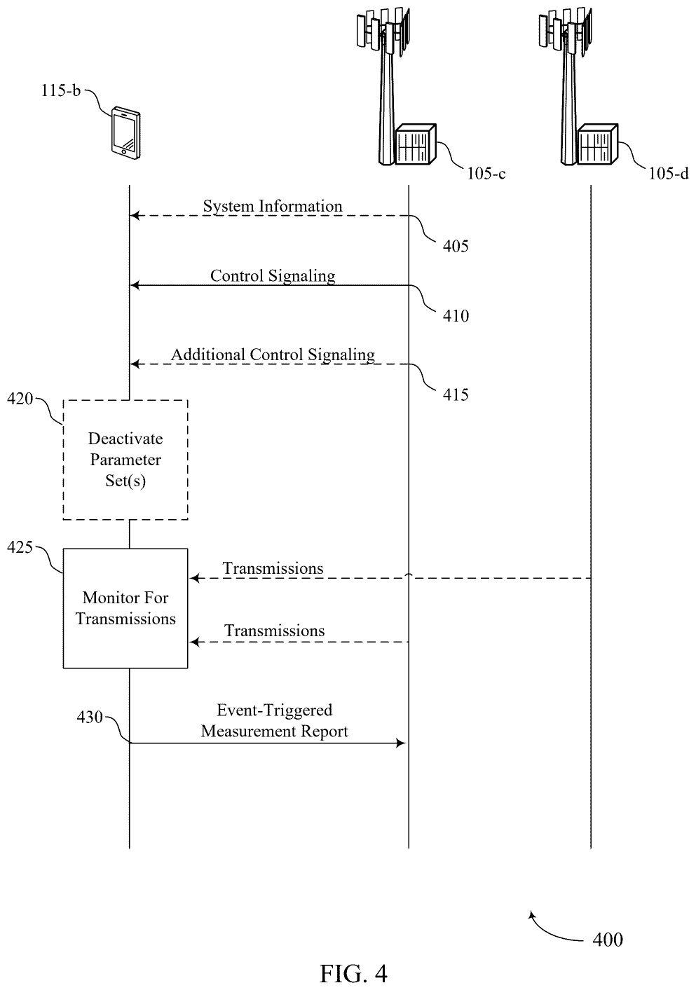

FIG. 4 shows an example of a process flow 400 that supports configuring multiple event condition parameter sets for UE-initiated beam reporting in accordance with one or more aspects of the present disclosure. The process flow 400 may implement or may be implemented by aspects of the wireless communications system 100, the wireless communications system 200, the measurement quality diagram 300-a, or the measurement quality diagram 300-b. For example, process flow 400 may be implemented by a UE 115 (e.g., a UE 115-b) or one or more network entities 105 (e.g., a network entity 105-c, a network entity 105-d), which may be examples of the corresponding devices as described with reference to FIG. 1.

In the following description of the process flow 400, the operations between the UE 115-b, the network entity 105-c, and the network entity 105-d may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 405, the UE 115-b may receive system information (e.g., an SIB) from the network entity 105-c (e.g., a serving cell). In some examples, the system information may indicate a default set of parameters for the UE 115-b to use to evaluate an entering condition or a leaving condition for an event that triggers the UE 115-b to transmit an event-triggered measurement report for LTM to the network entity 105-c. As described herein, the entering condition may be a condition associated with triggering reporting measurements associated with the network entity 105-c or the network entity 105-d (e.g., a neighboring network entity). The leaving condition may be a condition associated with terminating reporting of measurements associated with the network entity 105-c or the network entity 105-d.

Additionally, or alternatively, the system information may indicate a plurality of sets of parameters for the UE 115-b to use to evaluate the entering condition or the leaving condition and/or a default set of parameters of the plurality of sets of parameters. Additionally, or alternatively, the default set of parameters, the plurality of sets of parameters, and/or the default set of parameters of the plurality of sets of parameters may be defined according to a rule in a technical specification. In some examples, each of the plurality of sets of paraments may be associated with an ID (e.g., an explicit ID or an ordinal index).

At 410, the UE 115-b may receive control signaling (e.g., RRC) from the network entity 105-c indicating an event configuration for the event. The event configuration may indicate at least one set of parameters of the plurality of sets of parameters. For example, the event configuration may indicate a first set of parameters for the entering condition and/or a second set of parameters for the leaving condition. In some examples, one or more parameters of the first set of parameters and the second set of parameters may be the same or may be different. In some examples, the control signaling may indicate multiple values for a first parameter of the plurality of sets of parameters, where a first value of the first parameter applies to the first set of parameters and a second value of the first parameter applies to the second set of parameters. In some examples, the control signaling may indicate all of the sets of parameters of the plurality of sets of parameters. In some examples, each of the plurality of sets of paraments may be associated with an ID (e.g., an explicit ID or an ordinal index).

In some examples, the control signaling may indicate a single set of parameters (e.g., the first set of parameters or the second set of parameters), and the indicated set of parameters may apply to one of the entering condition or the leaving condition. For example, the control signaling may indicate whether the indicated set of parameters is the first set of parameters or the second set of parameters. Additionally, or alternatively, the UE 115-b may determine whether the indicated set of parameters is the first set of parameters or the second set of parameters based on a rule defined in a technical specification. In such examples, the other of the first set of parameters or the second set of parameters may be the default set of parameters.

In some examples, at 415, the UE 115-b may receive additional control signaling (e.g., MAC-CE, DCI) from the network entity 105-c that indicates one or more of the plurality of sets of parameters. For example, if the control signaling indicates all of the plurality of sets of parameters, the additional control signaling may indicate which of the plurality of sets of parameters is the first set of parameters and which of the plurality of sets of parameters is the second set of parameters. In some examples, the additional control signaling may indicate the ID (e.g., the explicit ID, the ordinal index) of the first set of parameters and the second set of parameters. In some examples, the UE 115-b may use the default set of parameters (e.g., or a set of parameters associated with a default explicit ID or ordinal index) for one or both of the first set of parameters (e.g., prior to receiving the additional control signaling).

In some examples, the additional control signaling may indicate an update to one or more of the plurality of sets of parameters. For example, the control signaling may indicate values of the first set of parameters and/or the second set of parameters, and the additional control signaling may update one or more values of the first set of parameters and/or the second set of parameters. Additionally, or alternatively, the control signaling (e.g., or the system information) may indicate values of all of the plurality of sets of parameters, and the additional control signaling may update one or more values of the plurality of sets of parameters. In some examples, the additional control signaling may activate and/or deactivate one or more sets of parameters for the UE 115-b to use as the first set of parameters and/or the second set of parameters.

In some examples, at 420, the UE 115-b may deactivate one or more sets of parameters. For example, the UE 115-b may deactivate one or more sets of parameters in response to receiving the additional control signaling that activates one or more different sets of parameters as the first set of parameters and/or the second set of parameters. In some examples, the additional control signaling may be a deactivation message that indicates for the UE 115-b to deactivate an activated set of parameters (e.g., a set of parameters that is activated for the first set of parameters or the second set of parameters). In such examples, the UE 115-b may use the default set of parameters (e.g., or a set of parameters associated with a default explicit ID or ordinal index) for the first set of parameters or the second set of parameters (e.g., until receiving an activation message that activates a set of parameters for the first set of parameters or the second set of parameters).

At 425, the UE 115-b may monitor for one or more transmissions from the network entity 105-c and/or the network entity 105-d. For example, the UE 115-b may monitor one or more beams of the network entity 105-c and/or the network entity 105-d to receive one or more reference signals (e.g., CSI-RSs, SSBs) from the network entity 105-c and/or the network entity 105-d. The UE 115-b may perform measurements (e.g., reference signal received power (RSRP) measurements, signal quality measurements, signal-to-noise ratios (SNRs), signal-to-noise plus interference ratios (SNIRs)) of the one or more transmissions.

At 430, the UE 115-b may transmit the event-triggered measurement report (e.g., a measurement report for LTM) to the network entity 105-c. For example, the UE 115-b may determine that one of the entering condition or the leaving condition is satisfied for one or both of the network entity 105-c or the network entity 105-d based on the first set of parameters and/or the second set of parameters, and may therefore be triggered to transmit the measurement report. In some examples (e.g., if the entering condition is satisfied for one or both of the network entity 105-c or the network entity 105-d), the measurement report may include the measurements associated with each network entity 105 for which the entering condition is satisfied. Additionally, or alternatively, if the leaving condition is satisfied for one or both of the network entity 105-c or the network entity 105-d the measurement report may omit the measurements associated with each network entity 105 for which the leaving condition is satisfied.

In some examples, the measurement report may indicate, to the network entity 105-c, one or more network entities 105 for which the leaving condition is satisfied (e.g., such that the network entity 105-c may reconfigure the UE 115-b to monitor for transmissions from one or more other network entities 105). In some examples, the network entity 105-c may indicate for the UE 115-b to perform a cell switch procedure based on the measurement report. For example, if the UE 115-b indicates that the network entity 105-d is associated with a relatively higher measurement quality than the network entity 105-c, the network entity 105-c may indicate for the UE 115-b to perform a cell switch to switch to a cell of the network entity 105-d.

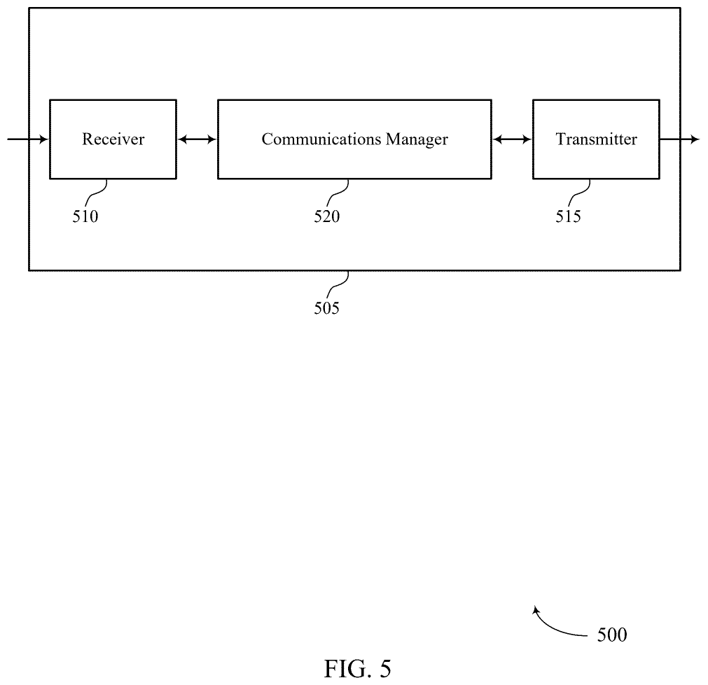

FIG. 5 shows a block diagram 500 of a device 505 that supports configuring multiple event condition parameter sets for UE-initiated beam reporting in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to configuring multiple event condition parameter sets for UE-initiated beam reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configuring multiple event condition parameter sets for UE-initiated beam reporting). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of configuring multiple event condition parameter sets for UE-initiated beam reporting as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity. The communications manager 520 is capable of, configured to, or operable to support a means for monitoring for one or more transmissions from the serving network entity or the neighboring network entity based on the control signaling. The communications manager 520 is capable of, configured to, or operable to support a means for transmitting an event-triggered measurement report for LTM based on at least one measurement of the one or more transmissions satisfying one or more parameters of the first set of parameters or one or more parameters of the second set of parameters.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for configuring multiple parameter sets per event for UE-initiated beam reporting, which may result in more efficient utilization of communication resources.

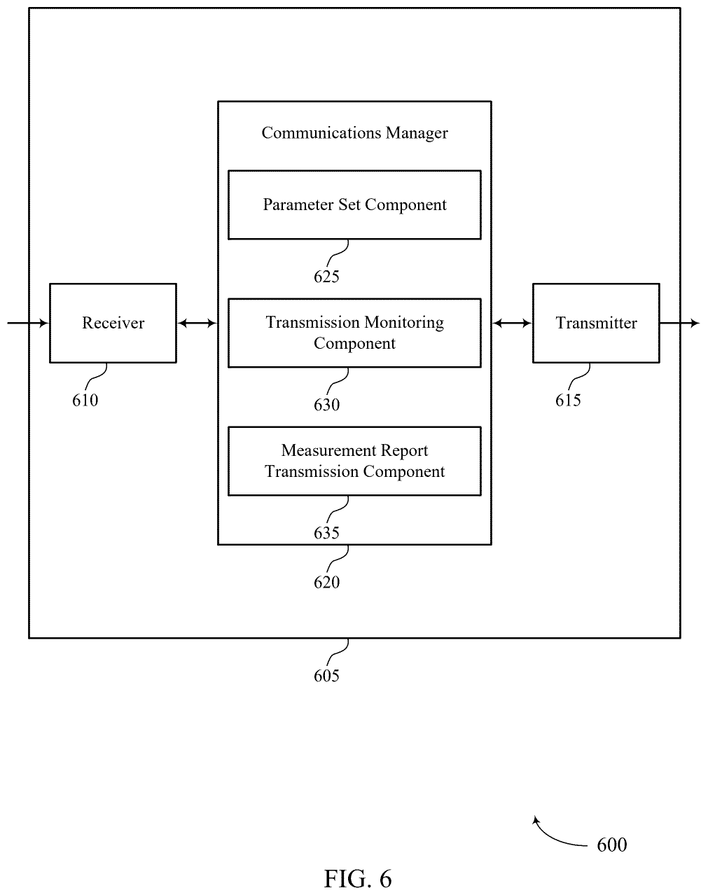

FIG. 6 shows a block diagram 600 of a device 605 that supports configuring multiple event condition parameter sets for UE-initiated beam reporting in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to configuring multiple event condition parameter sets for UE-initiated beam reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuring multiple event condition parameter sets for UE-initiated beam reporting). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of configuring multiple event condition parameter sets for UE-initiated beam reporting as described herein. For example, the communications manager 620 may include a parameter set component 625, a transmission monitoring component 630, a measurement report transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The parameter set component 625 is capable of, configured to, or operable to support a means for receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity. The transmission monitoring component 630 is capable of, configured to, or operable to support a means for monitoring for one or more transmissions from the serving network entity or the neighboring network entity based on the control signaling. The measurement report transmission component 635 is capable of, configured to, or operable to support a means for transmitting an event-triggered measurement report for LTM based on at least one measurement of the one or more transmissions satisfying one or more parameters of the first set of parameters or one or more parameters of the second set of parameters.

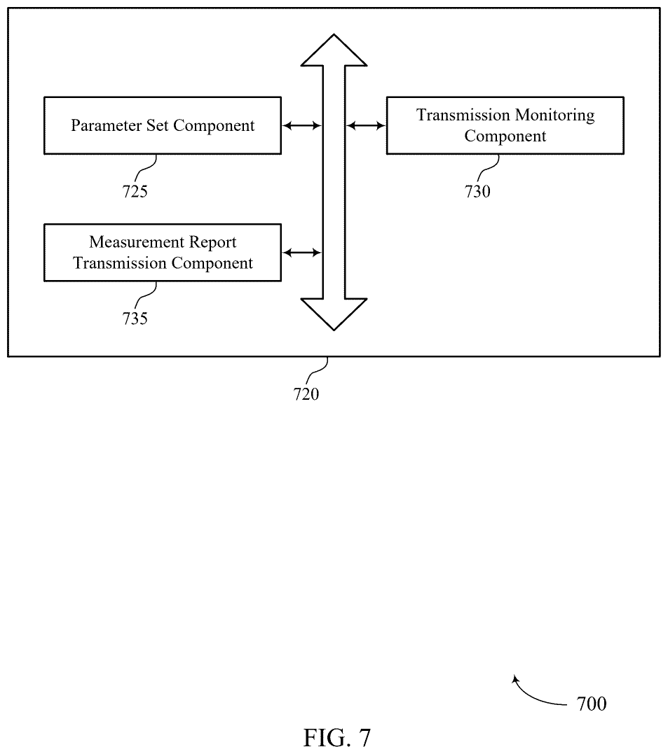

FIG. 7 shows a block diagram 700 of a communications manager 720 that supports configuring multiple event condition parameter sets for UE-initiated beam reporting in accordance with one or more aspects of the present disclosure. The communications manager 720 may be an example of aspects of a communications manager 520, a communications manager 620, or both, as described herein. The communications manager 720, or various components thereof, may be an example of means for performing various aspects of configuring multiple event condition parameter sets for UE-initiated beam reporting as described herein. For example, the communications manager 720 may include a parameter set component 725, a transmission monitoring component 730, a measurement report transmission component 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The parameter set component 725 is capable of, configured to, or operable to support a means for receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity. The transmission monitoring component 730 is capable of, configured to, or operable to support a means for monitoring for one or more transmissions from the serving network entity or the neighboring network entity based on the control signaling. The measurement report transmission component 735 is capable of, configured to, or operable to support a means for transmitting an event-triggered measurement report for LTM based on at least one measurement of the one or more transmissions satisfying one or more parameters of the first set of parameters or one or more parameters of the second set of parameters.

In some examples, the first set of parameters is different from the second set of parameters.

In some examples, to support receiving the control signaling, the parameter set component 725 is capable of, configured to, or operable to support a means for receiving the control signaling indicating the first set of parameters and the second set of parameters.

In some examples, to support receiving the control signaling, the parameter set component 725 is capable of, configured to, or operable to support a means for receiving an indication of a set of multiple values for a parameter, where a first value of the set of multiple values applies to the first set of parameters and where a second value of the set of multiple values applies to the second set of parameters.

In some examples, to support receiving the control signaling, the parameter set component 725 is capable of, configured to, or operable to support a means for receiving an indication of one of the first set of parameters or the second set of parameters, where the other of the first set of parameters or the second set of parameters is a default set of parameters.

In some examples, to support receiving the control signaling, the parameter set component 725 is capable of, configured to, or operable to support a means for receiving an indication of whether the control signaling indicates the first set of parameters or the second set of parameters.

In some examples, to support receiving the control signaling, the parameter set component 725 is capable of, configured to, or operable to support a means for receiving an indication of the set of multiple sets of parameters.

In some examples, the parameter set component 725 is capable of, configured to, or operable to support a means for receiving additional control signaling indicating an identifier associated with the first set of parameters, the second set of parameters, or both.

In some examples, the parameter set component 725 is capable of, configured to, or operable to support a means for deactivating one or more sets of parameters based on receiving the additional control signaling.

In some examples, the parameter set component 725 is capable of, configured to, or operable to support a means for receiving a deactivation message that deactivates a set of parameters of the set of multiple sets of parameters, where the first set of parameters, the second set of parameters, or both are a default set of parameters based on the deactivation message.

In some examples, the first set of parameters, the second set of parameters, or both are a default set of parameters of the set of multiple sets of parameters.

In some examples, the parameter set component 725 is capable of, configured to, or operable to support a means for receiving system information indicating the default set of parameters.

In some examples, the first set of parameters, the second set of parameters, or both are associated with a default parameter identifier.

In some examples, the default set of parameters is defined according to a rule.

In some examples, the parameter set component 725 is capable of, configured to, or operable to support a means for receiving additional control signaling indicating an update to one or more sets of parameters of the set of multiple sets of parameters.

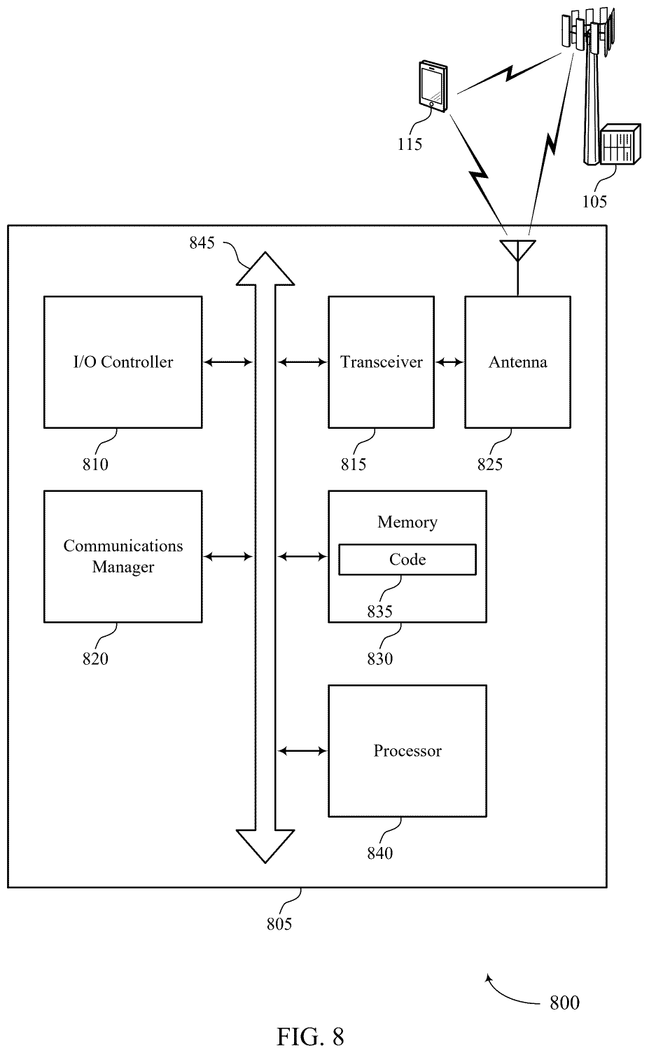

FIG. 8 shows a diagram of a system 800 including a device 805 that supports configuring multiple event condition parameter sets for UE-initiated beam reporting in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting configuring multiple event condition parameter sets for UE-initiated beam reporting). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity. The communications manager 820 is capable of, configured to, or operable to support a means for monitoring for one or more transmissions from the serving network entity or the neighboring network entity based on the control signaling. The communications manager 820 is capable of, configured to, or operable to support a means for transmitting an event-triggered measurement report for LTM based on at least one measurement of the one or more transmissions satisfying one or more parameters of the first set of parameters or one or more parameters of the second set of parameters.

By including or configuring the communications manager 820 in accordance with examples as described herein, the device 805 may support techniques for configuring multiple parameter sets per event for UE-initiated beam reporting, which may result in improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of configuring multiple event condition parameter sets for UE-initiated beam reporting as described herein, or the at least one processor 840 and the at least one memory 830 may be otherwise configured to, individually or collectively, perform or support such operations.

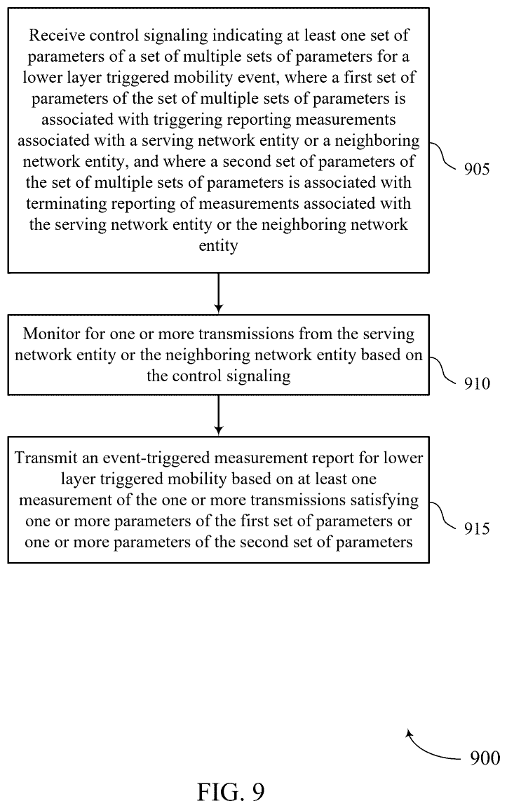

FIG. 9 shows a flowchart illustrating a method 900 that supports configuring multiple event condition parameter sets for UE-initiated beam reporting in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity. The operations of 905 may be performed in accordance with examples as disclosed herein. In some examples, aspects of the operations of 905 may be performed by a parameter set component 725 as described with reference to FIG. 7.

At 910, the method may include monitoring for one or more transmissions from the serving network entity or the neighboring network entity based on the control signaling. The operations of 910 may be performed in accordance with examples as disclosed herein. In some examples, aspects of the operations of 910 may be performed by a transmission monitoring component 730 as described with reference to FIG. 7.

At 915, the method may include transmitting an event-triggered measurement report for LTM based on at least one measurement of the one or more transmissions satisfying one or more parameters of the first set of parameters or one or more parameters of the second set of parameters. The operations of 915 may be performed in accordance with examples as disclosed herein. In some examples, aspects of the operations of 915 may be performed by a measurement report transmission component 735 as described with reference to FIG. 7.

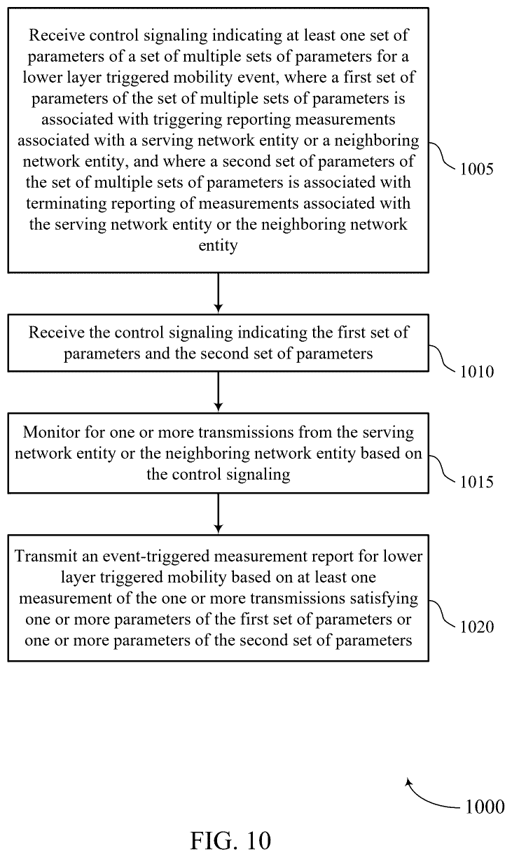

FIG. 10 shows a flowchart illustrating a method 1000 that supports configuring multiple event condition parameter sets for UE-initiated beam reporting in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity. The operations of 1005 may be performed in accordance with examples as disclosed herein. In some examples, aspects of the operations of 1005 may be performed by a parameter set component 725 as described with reference to FIG. 7.

At 1010, the method may include receiving the control signaling indicating the first set of parameters and the second set of parameters. The operations of 1010 may be performed in accordance with examples as disclosed herein. In some examples, aspects of the operations of 1010 may be performed by a parameter set component 725 as described with reference to FIG. 7.

At 1015, the method may include monitoring for one or more transmissions from the serving network entity or the neighboring network entity based on the control signaling. The operations of 1015 may be performed in accordance with examples as disclosed herein. In some examples, aspects of the operations of 1015 may be performed by a transmission monitoring component 730 as described with reference to FIG. 7.

At 1020, the method may include transmitting an event-triggered measurement report for LTM based on at least one measurement of the one or more transmissions satisfying one or more parameters of the first set of parameters or one or more parameters of the second set of parameters. The operations of 1020 may be performed in accordance with examples as disclosed herein. In some examples, aspects of the operations of 1020 may be performed by a measurement report transmission component 735 as described with reference to FIG. 7.

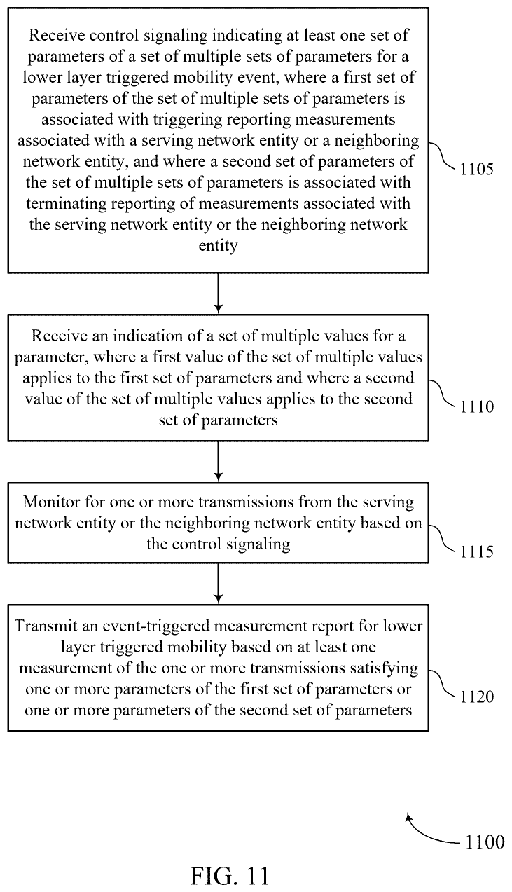

FIG. 11 shows a flowchart illustrating a method 1100 that supports configuring multiple event condition parameter sets for UE-initiated beam reporting in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving control signaling indicating at least one set of parameters of a set of multiple sets of parameters for a LTM event, where a first set of parameters of the set of multiple sets of parameters is associated with triggering reporting measurements associated with a serving network entity or a neighboring network entity, and where a second set of parameters of the set of multiple sets of parameters is associated with terminating reporting of measurements associated with the serving network entity or the neighboring network entity. The operations of 1105 may be performed in accordance with examples as disclosed herein. In some examples, aspects of the operations of 1105 may be performed by a parameter set component 725 as described with reference to FIG. 7.

At 1110, the method may include receiving an indication of a set of multiple values for a parameter, where a first value of the set of multiple values applies to the first set of parameters and where a second value of the set of multiple values applies to the second set of parameters. The operations of 1110 may be performed in accordance with examples as disclosed herein. In some examples, aspects of the operations of 1110 may be performed by a parameter set component 725 as described with reference to FIG. 7.

At 1115, the method may include monitoring for one or more transmissions from the serving network entity or the neighboring network entity based on the control signaling. The operations of 1115 may be performed in accordance with examples as disclosed herein. In some examples, aspects of the operations of 1115 may be performed by a transmission monitoring component 730 as described with reference to FIG. 7.

At 1120, the method may include transmitting an event-triggered measurement report for LTM based on at least one measurement of the one or more transmissions satisfying one or more parameters of the first set of parameters or one or more parameters of the second set of parameters. The operations of 1120 may be performed in accordance with examples as disclosed herein. In some examples, aspects of the operations of 1120 may be performed by a measurement report transmission component 735 as described with reference to FIG. 7.

The following provides an overview of aspects of the present disclosure:

Aspect 1: A method for wireless communications at a UE, comprising: receiving control signaling indicating at least one set of parameters of a plurality of sets of parameters for a LTM event, wherein a first set of parameters of the plurality of sets of parameters is associated with triggering reporting measurements associated with a serving network entity or a neighboring network entity, and wherein a second set of parameters of the plurality of sets of parameters is associated with terminating reporting of measurements associated with the serving network entity or the neighboring network entity; monitoring for one or more transmissions from the serving network entity or the neighboring network entity based at least in part on the control signaling; and transmitting an event-triggered measurement report for LTM based at least in part on at least one measurement of the one or more transmissions satisfying one or more parameters of the first set of parameters or one or more parameters of the second set of parameters.

Aspect 2: The method of aspect 1, wherein the first set of parameters is different from the second set of parameters.

Aspect 3: The method of any of aspects 1 through 2, wherein receiving the control signaling comprises: receiving the control signaling indicating the first set of parameters and the second set of parameters.

Aspect 4: The method of any of aspects 1 through 3, wherein receiving the control signaling comprises: receiving an indication of a plurality of values for a parameter, wherein a first value of the plurality of values applies to the first set of parameters and wherein a second value of the plurality of values applies to the second set of parameters.

Aspect 5: The method of any of aspects 1 through 4, wherein receiving the control signaling comprises: receiving an indication of one of the first set of parameters or the second set of parameters, wherein the other of the first set of parameters or the second set of parameters is a default set of parameters.

Aspect 6: The method of aspect 5, wherein receiving the control signaling comprises: receiving an indication of whether the control signaling indicates the first set of parameters or the second set of parameters.

Aspect 7: The method of any of aspects 1 through 6, wherein receiving the control signaling comprises: receiving an indication of the plurality of sets of parameters.

Aspect 8: The method of aspect 7, further comprising: receiving additional control signaling indicating an ID associated with the first set of parameters, the second set of parameters, or both.

Aspect 9: The method of aspect 8, further comprising: deactivating one or more sets of parameters based at least in part on receiving the additional control signaling.

Aspect 10: The method of any of aspects 7 through 9, further comprising: receiving a deactivation message that deactivates a set of parameters of the plurality of sets of parameters, wherein the first set of parameters, the second set of parameters, or both are a default set of parameters based at least in part on the deactivation message.

Aspect 11: The method of any of aspects 7 through 10, wherein the first set of parameters, the second set of parameters, or both are a default set of parameters of the plurality of sets of parameters.

Aspect 12: The method of aspect 11, further comprising: receiving system information indicating the default set of parameters.

Aspect 13: The method of any of aspects 11 through 12, wherein the first set of parameters, the second set of parameters, or both are associated with a default parameter ID.

Aspect 14: The method of any of aspects 11 through 13, wherein the default set of parameters is defined according to a rule.

Aspect 15: The method of any of aspects 7 through 14, further comprising: receiving additional control signaling indicating an update to one or more sets of parameters of the plurality of sets of parameters.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating at least one set of parameters of a plurality of sets of parameters for a lower layer triggered mobility event, wherein a first set of parameters of the plurality of sets of parameters is associated with triggering reporting measurements associated with a serving network entity or a neighboring network entity, and wherein a second set of parameters of the plurality of sets of parameters is associated with terminating reporting of measurements associated with the serving network entity or the neighboring network entity;
monitor for one or more transmissions from the serving network entity or the neighboring network entity based at least in part on the control signaling; and
transmit an event-triggered measurement report for lower layer triggered mobility based at least in part on at least one measurement of the one or more transmissions satisfying one or more parameters of the first set of parameters or one or more parameters of the second set of parameters.

2. The UE of claim 1, wherein the first set of parameters is different from the second set of parameters.

3. The UE of claim 1, wherein, to receive the control signaling, the one or more processors are individually or collectively operable to execute the code to cause the UE to:
receive the control signaling indicating the first set of parameters and the second set of parameters.

4. The UE of claim 1, wherein, to receive the control signaling, the one or more processors are individually or collectively operable to execute the code to cause the UE to:
receive an indication of a plurality of values for a parameter, wherein a first value of the plurality of values applies to the first set of parameters and wherein a second value of the plurality of values applies to the second set of parameters.

5. The UE of claim 1, wherein, to receive the control signaling, the one or more processors are individually or collectively operable to execute the code to cause the UE to:
receive an indication of one of the first set of parameters or the second set of parameters, wherein the other of the first set of parameters or the second set of parameters is a default set of parameters.

6. The UE of claim 5, wherein, to receive the control signaling, the one or more processors are individually or collectively operable to execute the code to cause the UE to:
receive an indication of whether the control signaling indicates the first set of parameters or the second set of parameters.

7. The UE of claim 1, wherein, to receive the control signaling, the one or more processors are individually or collectively operable to execute the code to cause the UE to:
receive an indication of the plurality of sets of parameters.

8. The UE of claim 7, wherein the one or more processors are individually or collectively further operable to execute the code to cause the UE to:
receive additional control signaling indicating an identifier associated with the first set of parameters, the second set of parameters, or both.

9. The UE of claim 8, wherein the one or more processors are individually or collectively further operable to execute the code to cause the UE to:
deactivate one or more sets of parameters based at least in part on receiving the additional control signaling.

10. The UE of claim 7, wherein the one or more processors are individually or collectively further operable to execute the code to cause the UE to:
receive a deactivation message that deactivates a set of parameters of the plurality of sets of parameters, wherein the first set of parameters, the second set of parameters, or both are a default set of parameters based at least in part on the deactivation message.

11. The UE of claim 7, wherein the first set of parameters, the second set of parameters, or both are a default set of parameters of the plurality of sets of parameters.

12. The UE of claim 11, wherein the one or more processors are individually or collectively further operable to execute the code to cause the UE to:
receive system information indicating the default set of parameters.

13. The UE of claim 11, wherein the first set of parameters, the second set of parameters, or both are associated with a default parameter identifier.

14. The UE of claim 11, wherein the default set of parameters is defined according to a rule.

15. The UE of claim 7, wherein the one or more processors are individually or collectively further operable to execute the code to cause the UE to:
receive additional control signaling indicating an update to one or more sets of parameters of the plurality of sets of parameters.

16. A method for wireless communications at a user equipment (UE), comprising:
receiving control signaling indicating at least one set of parameters of a plurality of sets of parameters for a lower layer triggered mobility event, wherein a first set of parameters of the plurality of sets of parameters is associated with triggering reporting measurements associated with a serving network entity or a neighboring network entity, and wherein a second set of parameters of the plurality of sets of parameters is associated with terminating reporting of measurements associated with the serving network entity or the neighboring network entity;
monitoring for one or more transmissions from the serving network entity or the neighboring network entity based at least in part on the control signaling; and
transmitting an event-triggered measurement report for lower layer triggered mobility based at least in part on at least one measurement of the one or more transmissions satisfying one or more parameters of the first set of parameters or one or more parameters of the second set of parameters.

17. The method of claim 16, wherein the first set of parameters is different from the second set of parameters.

18. The method of claim 16, wherein receiving the control signaling comprises:
receiving the control signaling indicating the first set of parameters and the second set of parameters.

19. The method of claim 16, wherein receiving the control signaling comprises:
receiving an indication of a plurality of values for a parameter, wherein a first value of the plurality of values applies to the first set of parameters and wherein a second value of the plurality of values applies to the second set of parameters.

20. A non-transitory computer-readable medium storing code for wireless communications, the code comprising instructions executable by one or more processors to:
receive control signaling indicating at least one set of parameters of a plurality of sets of parameters for a lower layer triggered mobility event, wherein a first set of parameters of the plurality of sets of parameters is associated with triggering reporting measurements associated with a serving network entity or a neighboring network entity, and wherein a second set of parameters of the plurality of sets of parameters is associated with terminating reporting of measurements associated with the serving network entity or the neighboring network entity;
monitor for one or more transmissions from the serving network entity or the neighboring network entity based at least in part on the control signaling; and
transmit an event-triggered measurement report for lower layer triggered mobility based at least in part on at least one measurement of the one or more transmissions satisfying one or more parameters of the first set of parameters or one or more parameters of the second set of parameters.
